(19) United States
(12) Patent Application Publication
(10) Pub. No.: US 2023/0289244 A1
(43) Pub. Date: Sep. 14, 2023

(54) PERIPHERAL DEVICE POSITIONS

(71) Applicant: Hewlett-Packard Development Company, L.P., Spring, TX (US)

(72) Inventors: Christopher Allan Steven, Spring, TX (US); Paul Forrest Carter Davis, Houston, TX (US)

(21) Appl. No.: 17/581,556

(22) Filed: Jan. 21, 2022

(51) Int. Cl. G06F 9/54; G06F 3/02; H04W 4/20

(52) U.S. Cl. CPC G06F 9/546; G06F 3/0219; H04W 4/20

(57) ABSTRACT

Examples of peripheral input devices are described herein. In some examples, a first peripheral input device includes a sensor to receive a signal from a second peripheral input device. In some examples, the first peripheral input device includes circuitry coupled to the sensor. In some examples, the circuitry is to determine a peripheral input device position relative to a keyboard based on the signal. In some examples, the circuitry is to send, to a host device, a message indicating the peripheral input device position relative to the keyboard.

### BACKGROUND

The use of electronic devices has expanded. A computing device is a kind of electronic device that includes electronic circuitry for performing processing. As processing capabilities have expanded, computing devices have been utilized to perform more functions. For example, a variety of computing devices are used for work, communication, and entertainment. Computing devices may be linked to other devices and may communicate with other devices.

### BRIEF DESCRIPTION OF THE DRAWINGS

FIG. 1 is a block diagram of an example of a first peripheral input device that may be used in peripheral device position detection;

FIG. 2 is a flow diagram illustrating an example of a method for determining a relative position of an peripheral input device;

FIG. 3 is a block diagram of an example of a host device, a mouse, and a keyboard that may be used in relative position determination; and

FIG. 4 is a block diagram illustrating an example of a computer-readable medium for peripheral input device control.

### DETAILED DESCRIPTION

An electronic device is a device that includes electronic circuitry (e.g., integrated circuitry, a chip(s), etc.). Examples of electronic devices include computing devices, smartphones, tablet devices, game consoles, etc. Some examples of electronic devices may utilize circuitry (e.g., controller(s), processor(s), or a combination thereof, etc.) to perform an operation or operations. In some examples, electronic devices may execute instructions stored in memory to perform the operation(s). Instructions may be code, programming, or a combination thereof that specifies functionality or operation of the circuitry. In some examples, instructions may be stored in memory (e.g., Read-Only Memory (ROM), Erasable Programmable Read-Only Memory (EPROM), Electrically Erasable Programmable Read-Only Memory (EEPROM), flash memory, dynamic random access memory (DRAM), synchronous DRAM (SDRAM), magnetoresistive random-access memory (MRAM), phase-change random-access memory (PCRAM), hard disk drive (HDD), solid state drive (SSD), optical drive, etc.). In some examples, different circuitries in an electronic device may store separate instructions, utilize separate instructions for operation, or a combination thereof.

In some examples, an electronic device may be linked to another electronic device or devices using a wired link, a wireless link, or a combination thereof. For example, an electronic device (e.g., computing device, etc.) may include a wired communication interface(s) (e.g., port(s), interface circuitry(ies), etc.), a wireless communication interface(s) (e.g., antenna(s), wireless transceiver(s), etc.), or a combination thereof for linking peripheral device(s). Examples of wired interfaces include a Universal Serial Bus (USB) interface (e.g., USB Type-C (USB-C^{®}) interface), Lightning^{®} interface, Ethernet interface, Thunderbolt™ interface, etc. Examples of wireless interfaces include a Bluetooth^{Ⓡ}interface, an Institute of Electrical and Electronics Engineers (IEEE) 802.11 (e.g., WI-FI^{Ⓡ}) interface, Zigbee^{®} interface, etc.

A link between electronic devices may be a direct link (e.g., without an intervening device) or an indirect link (e.g., with an intervening device or devices). For instance, a link may be established between electronic devices over a network using a docking device(s), hub(s), repeater(s), or a combination thereof, etc.

A peripheral device is an electronic device to provide input for a host device or to generate an output from a host device. For instance, a peripheral device may be linked to a host device and/or may provide auxiliary functionality relative to the host device. In some examples, a peripheral device may be an accessory to a host device. A peripheral input device is a peripheral device to provide an input to a host device. Examples of peripheral input devices include a mouse, keyboard, camera, stylus pad, track pad, microphone, controller, remote control, etc. A host device is an electronic device with an operating system (OS) and a network component(s) capable of accessing the Internet. Examples of host devices include desktop computers, laptop computers, servers, smartphones, tablet devices, etc. In some examples, the terms “peripheral device” and “peripheral input device” exclude host devices.

In some examples, a peripheral input device is linked to a host device with a wired connection. For example, a peripheral input device may be linked to a host device via a USB, Lightning^{Ⓡ}, etc., connection. In some examples, a peripheral input device is linked to a host device with a wireless connection. For example, a peripheral input device may be linked to a host device via a Bluetooth^{Ⓡ}, WI-FI^{Ⓡ}, Zigbee^{Ⓡ}, etc., connection. In some examples, a peripheral input device may provide input to the host device via a wired link, a wireless link, or a combination thereof. For instance, a peripheral input device may provide detected input (e.g., directional movement, click events, button events, button presses, motion input, taps, contact locations, audio, video, etc.).

In some contexts (e.g., shared environments, education, manufacturing, home office, etc.), different users may utilize an electronic device. Different users may interface with the electronic device differently. For instance, some users may be right-handed, some users may be left-handed, some users may utilize a stylus pad, etc. In some approaches, for instance, a left-handed user may change device settings to customize a mouse or may use a mouse with their right hand. This may reduce productivity and may produce a barrier for left-handed users. In some approaches, companies may set up a single left-handed workstation and multiple right-handed workstations in hospitals and manufacturing plants, which may force a nurse or worker to travel to a specified workstation.

Some examples of the techniques described herein may provide inclusive approaches to accommodate a variety of users. In some examples, two antennas may be utilized, where one antenna is located on the right side of a keyboard and another antenna is located on the left side of the keyboard. In some examples, a radio frequency (RF) barrier between the antennas may be utilized to enhance detection of whether an RF signal is coming from the left side or the right side of the keyboard. In some examples, a directional Bluetooth^{Ⓡ}receiver may be utilized to detect whether a mouse is positioned on the right side or left side of a keyboard. Based on the detection, mouse settings may be adjusted to swap buttons, programmable switches, electromechanical switches, or a combination thereof. For instance, once a position is detected, a host device may be notified by a keyboard command, and an OS may perform the setting adjustment. Some examples of the techniques described herein may be utilized with virtual keypads or other devices to allow buttons or switches on the keyboard to be adjusted to accommodate a user. In some examples, performing the changes based on the position of the mouse may be automatic. For instance, settings adjustment may be performed seamlessly from a perspective of a user.

Throughout the drawings, similar reference numbers may designate similar or identical elements. When an element is referred to without a reference number, this may refer to the element generally, without limitation to any particular drawing or figure. In some examples, the drawings are not to scale, and the size of some parts may be exaggerated to more clearly illustrate the example shown. Moreover, the drawings provide examples in accordance with the description. However, the description is not limited to the examples provided in the drawings.

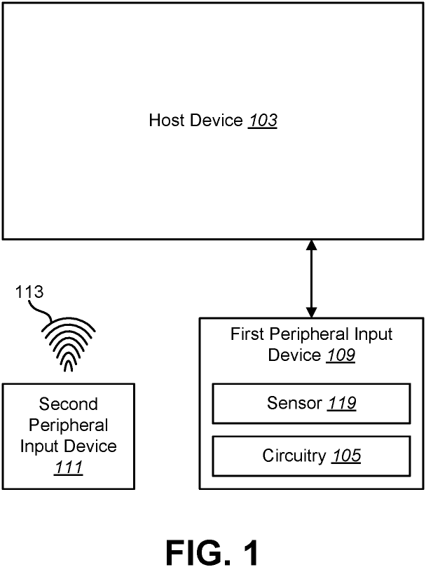

FIG. 1 is a block diagram of an example of a first peripheral input device 109 that may be used in peripheral device position detection. The first peripheral input device 109 may include a sensor 119 to detect a second peripheral input device 111. In some examples, the sensor 119 may be an RF sensor to receive a signal 113 from a second peripheral input device 111. In some examples, the sensor 119 may be circuitry to detect RF signals. For instance, the sensor 119 may include an antenna or antennas to receive an electromagnetic signal (e.g., the signal 113). In some examples, the sensor 119 may include an amplifier, demodulator, decoder, analog-to-digital converter (ADC), or a combination thereof. In some examples, the sensor 119 may include a radio frequency identification (RFID) reader(s) and/or a near-field communication (NFC) sensor(s). For instance, the sensor 119 may include a loop antenna(s) to detect an RFID tag and/or peer device embedded in the second peripheral device 111. In some examples, the sensor 119 may include an image sensor(s), depth sensor(s), proximity sensor(s), and/or infrared sensor(s) to detect the second peripheral device 111.

The first peripheral input device 109 may include circuitry 105 coupled to the sensor 119. For instance, the circuitry 105 may be coupled to the sensor 119 by a wire(s), bus, internal interface, etc. The circuitry 105 is circuitry to determine a relative position of a peripheral input device (e.g., a position of the first peripheral input device 109 or a position of the second peripheral input device 111). For instance, the circuitry 105 may be logic circuitry, a processor, an application specific integrated circuit (ASIC), field programmable gate array (FPGA), etc. In some examples, the circuitry 105 may determine a peripheral input device position (e.g., a position of the first peripheral input device 109 or a position of the second peripheral input device 111) relative to a keyboard based on the signal 113. In some examples, the first peripheral input device 109 may be the keyboard and the second peripheral input device 111 may be a mouse. For instance, the first peripheral input device 109 may determine a position of the second peripheral input device 111 (e.g., mouse) relative to the first peripheral input device 109 (e.g., keyboard). In some examples, the first peripheral input device 109 may be a mouse and the second peripheral input device 111 is the keyboard. For instance, the first peripheral input device 109 may determine a position of the first peripheral input device 109 (e.g., mouse) relative to the second peripheral input device 111 (e.g., keyboard).

In some examples, the position may indicate whether a peripheral input device is in a zone of a directional set (e.g., [left, right]; [left, right, front]; [left, right, front, back]; etc.) relative to a keyboard. For instance, the position may indicate whether a peripheral input device is to the left of a keyboard, to the right of a keyboard, in front of a keyboard, behind a keyboard, etc. In some examples, a directional set with two directions (e.g., [left, right]) may denote a left zone and a right zone from a center line that divides the keyboard in left and right halves. In some examples, a directional set with three zones (e.g., [left, right, front]) may denote a left zone, a right zone, and a front zone delineated by three lines intersecting at a center point of the keyboard, where a front left line extends through a front left corner of the keyboard, a front right line extends through a front right corner of the keyboard, and a back center line extends through a back center of the keyboard. For instance, a front zone may be delineated between the front left line and the front right line, the left zone may be delineated between the front left line and the back center line, and the right zone may be delineated between the front right line and the back center line. In some examples, a directional set with four zones (e.g., [left, right, front, back]) may denote a left zone, a right zone, a front zone, and a back zone delineated by four lines intersecting at a center point of the keyboard, where a front left line extends through a front left corner of the keyboard, a front right line extends through a front right corner of the keyboard, a back left line extends through a back left corner of the keyboard, and a back right line extends through a back right corner of the keyboard. For instance, a front zone may be delineated between the front left line and the front right line, the left zone may be delineated between the front left line and the back left line, the right zone may be delineated between the front right line and the back right line, and the back zone may be delineated between the back left line and the back right line. In some examples, other quantities of zones and/or other zone boundaries may be utilized.

In some examples, the position (e.g., zone) of a peripheral input device may be determined based on an antenna or sensor that receives the signal 113 or based on an antenna or sensor that receives the signal 113 with a greatest signal strength. For instance, each antenna or each directional range relative to a sensor (e.g., directional sensor) may have a corresponding position (e.g., zone). In some examples, the sensor 119 includes a first antenna or sensor disposed at a first location of the first peripheral input device 109 (e.g., keyboard) and a second antenna or sensor disposed at a second location of the first peripheral input device 109 (e.g., keyboard). For instance, the first antenna or sensor may be located on a left side of the keyboard and the second antenna or sensor may be located on a right side of the keyboard (or vice versa). In some examples, the circuitry 105 may determine the peripheral input device position based on receiving the signal 113 by the first antenna or sensor while not receiving the signal 113 by the second antenna or sensor. In some examples, the circuitry 105 may determine the peripheral input device position based on receiving by the signal 113 by the first antenna or sensor while receiving the signal 113 with attenuated (e.g., lower) signal strength by the second antenna or sensor.

In some examples, the first peripheral input device 109 may include a signal barrier or barriers between antennas and/or sensors. For instance, the first peripheral input device 109 may include an RF barrier between a first antenna and a second antenna. An RF barrier is a material (e.g., ferromagnetic material) to block and/or attenuate RF signals. For instance, an RF barrier may be located between a first antenna on a left side of the first peripheral input device 109 and a second antenna on a right side of the first peripheral input device 109. When the signal 113 is received from a left side of the first peripheral input device 109 by the first antenna, the RF barrier may attenuate the signal 113 received by the second antenna and/or may block the signal 113 from reaching the second antenna. Accordingly, the circuitry 105 may determine that the second peripheral input device 111 is positioned to a left side of the first peripheral input device 109 due to the signal 113 being received by the first antenna (without the second antenna) or due to the signal 113 being received with greater signal strength at the first antenna than at the second antenna. In some examples, an RF barrier may be included with each antenna. For instance, a first antenna housing may include a first antenna on a left side of the first peripheral input device 109 and may include a first RF barrier on a right side of the first antenna housing, and/or a second antenna housing may include a second antenna on a right side of the first peripheral input device 109 and may include a second RF barrier on a left side of the second antenna housing. In some examples, another barrier(s) (e.g., optical barrier(s), ultrasound barrier(s), infrared barrier(s), etc.) may be located between sensors.

In some examples, the circuitry 105 may determine the peripheral input device position by identifying a signal correspondence. For instance, the second peripheral input device 111 may produce a signal 113 with multiple channels (e.g., spatial channels). For instance, the second peripheral input device 111 may include multiple antennas and/or transmitters (e.g., light source(s), infrared transmitter(s), RFID tag(s), RFID peer device(s), etc., to transmit the signal 113, where the antennas and/or transmitters are located differently on the second peripheral input device 111. In some examples, the second peripheral input device 111 may include antennas and/or transmitters corresponding to different zones as similarly described above with reference to the antennas and/or sensors of the first peripheral input device 109. For example, the second peripheral input device 111 may include a first antenna and/or transmitter on a left side of the second peripheral input device 111 and a second antenna and/or transmitter on a right side of the second peripheral input device 111, where the first antenna and/or transmitter and the second antenna and/or transmitter may transmit different signals or channels of the signal 113. A signal correspondence may indicate a position or zone based on a signal. For example, the sensor 119 may receive (using an antenna or antennas) the signal 113 and the circuitry 105 may identify a channel of the signal 113 (e.g., RF signal) that corresponds to a side of the second peripheral input device 111. For instance, the circuitry 105 may determine that a received channel (or strongest received channel, for example) is sent from the right side (e.g., an antenna and/or transmitter on the right side) of the second peripheral input device 111, which corresponds to the second peripheral input device 111 being positioned to the left of the first peripheral input device 109.

In some examples, the signal 113 may be a signal to communicate between the second peripheral input device 111 and a host device 103. For instance, the second peripheral input device 111 may be paired with the host device 103. The signal 113 may be based on the pairing (e.g., Bluetooth^{Ⓡ} pairing) between the second peripheral input device 111 and the host device 103. In some examples, the signal 113 may include input information from the second peripheral input device 111 to the host device 103. In some examples, the second peripheral input device 111 may not be paired with the first peripheral input device 109. For instance, a communication link may not be set up between the second peripheral input device 111 and the first peripheral input device 109. In some examples, the signal 113 may be intercepted and/or sensed for use in determining the relative positioning. In some examples, the first peripheral input device 109 may detect the signal 113 without decoding information from the signal 113. For instance, the first peripheral input device 109 may sniff the signal 113. In some examples, the first peripheral input device 109 may read an identifier of the second peripheral input device 111 from the signal 113 (without reading the input information of the second peripheral input device 111, for instance). In some examples, the first peripheral input device 109 may utilize the signal 113, which may be an interfering signal relative to first peripheral input device 109 communications, to determine the relative position.

In some examples, the sensor 119 may sense (e.g., read) the signal 113, where the signal 113 is produced by an RFID tag. For instance, the sensor 119 may include two RFID readers and/or antennas on different sides of the first peripheral input device 109 to produce an electromagnetic field(s) to energize an RFID tag included in the second peripheral input device. The RFID reader and/or antenna that reads the RFID tag (or that reads the RFID tag with greater signal strength, for instance) may be determined by the circuitry 105 to determine the position of the second peripheral input device 111.

In some examples, the sensor 119 may include an image sensor(s). For instance, the sensor 119 may include image sensors on different sides of the first peripheral input device 109 to detect the presence of the second peripheral input device 111. For instance, the second input peripheral device 111 may include a light source(s) to produce the signal 113 (e.g., a light signal). The image sensor that detects the signal 113 may be determined by the circuitry 105 to determine the position of the second peripheral input device 111. In some examples, the image sensor(s) may detect the second peripheral input device 111 based on a light characteristic. For instance, an image sensor may be utilized to detect a light characteristic (e.g., reflected light, absence of reflected light, optically detected motion, light pattern, etc.) from the second peripheral input device 111. The light characteristic may be an example of the signal 113. The image sensor that detects the light characteristic may be determined by the circuitry 105 to determine the position of the second peripheral input device 111. In some examples, a light detector(s) may be utilized instead of an image sensor(s).

In some examples, the sensor 119 may include a depth sensor(s). For instance, the sensor 119 may include depth sensors on different sides of the first peripheral input device 109 to detect the presence of the second peripheral input device 111. Examples of a depth sensor may include a time of flight (ToF) sensor, infrared depth sensor, stereoscopic camera, etc. A depth sensor may detect whether an object (e.g., the second peripheral input device 111) is positioned within a distance (e.g., 4 inches, 6 inches, 8 inches, etc.) from the depth sensor (e.g., the first peripheral input device 109). The depth sensor that detects the signal 113 (e.g., a reflection of a signal transmitted from the first peripheral input device 109 and/or light) may be determined by the circuitry 105 to determine the position of the second peripheral input device 111. For example, the depth sensor that detects the object within the distance may be determined by the circuitry 105 to determine the position of the second peripheral input device 111.

In some examples, the sensor 119 may include a proximity sensor(s). For instance, the sensor 119 may include proximity sensors on different sides of the first peripheral input device 109 to detect the presence of the second peripheral input device 111. Examples of a proximity sensor may include a magnetic proximity sensor, capacitive proximity sensor, inductive proximity sensor, infrared proximity sensor, ultrasonic proximity sensor, etc. A proximity sensor may detect whether an object (e.g., the second peripheral input device 111) is positioned within a distance (e.g., 4 inches, 6 inches, 8 inches, etc.) from the proximity sensor (e.g., the first peripheral input device 109). The proximity sensor that detects the signal 113 (e.g., magnetic field, electromagnetic field based on object presence, infrared light reflected from the first peripheral input device 109, ultrasound signal reflected from the first peripheral input device 109, etc.) may be determined by the circuitry 105 to determine the position of the second peripheral input device 111. For example, the proximity sensor that detects the object within the distance may be determined by the circuitry 105 to determine the position of the second peripheral input device 111.

In some examples, the circuitry 105 may send, to the host device 103, a message indicating the peripheral input device position relative to the keyboard. In some examples, the message may indicate a position (e.g., zone) of the second peripheral input device 111 relative to the first peripheral input device 109. In some examples, the message may indicate a position (e.g., zone) of the first peripheral input device 109 relative to the second peripheral input device 111. In some examples, the message may indicate an identifier of the peripheral input device.

In some examples, the first peripheral input device 109 may send the message to the host device 103 using a wired or wireless link. For instance, the first peripheral input device 109 may include a communication interface (e.g., Bluetooth^{Ⓡ} interface, USB interface, WI-FI^{Ⓡ}interface, etc.) to communicate with the host device 103. In some examples, the first peripheral input device 109 may wirelessly transmit the message to the host device 103 using an antenna or antennas used to receive the signal 113.

In some examples, the message may cause the host device 103 to determine whether to remap a peripheral input device button. For instance, the host device 103 may compare the indicated position of the peripheral input device (e.g., mouse) to a previous position stored in memory. In a case that the indicated position is different from the previous position, the host device 103 may determine to remap a peripheral input device button. For instance, the host device 103 may swap mouse button inputs in response to determining that the mouse has switched position relative to the keyboard (e.g., from a right side of the keyboard to a left side of the keyboard).

In some examples, the host device 103 may determine whether to remap a peripheral input device button based on an identifier indicated by the message. For instance, the host device 103 may check the identifier to verify that the detected signal 113 corresponds to a peripheral input device that is providing input to (e.g., paired with) the host device 103. If the identifier matches, the host device 103 may remap a peripheral input device button of the identifier peripheral input device. If the identifier does not match, the host device 103 may not perform the remapping (as the first peripheral input device 109 may have sent the message based on an extraneous device, for instance).

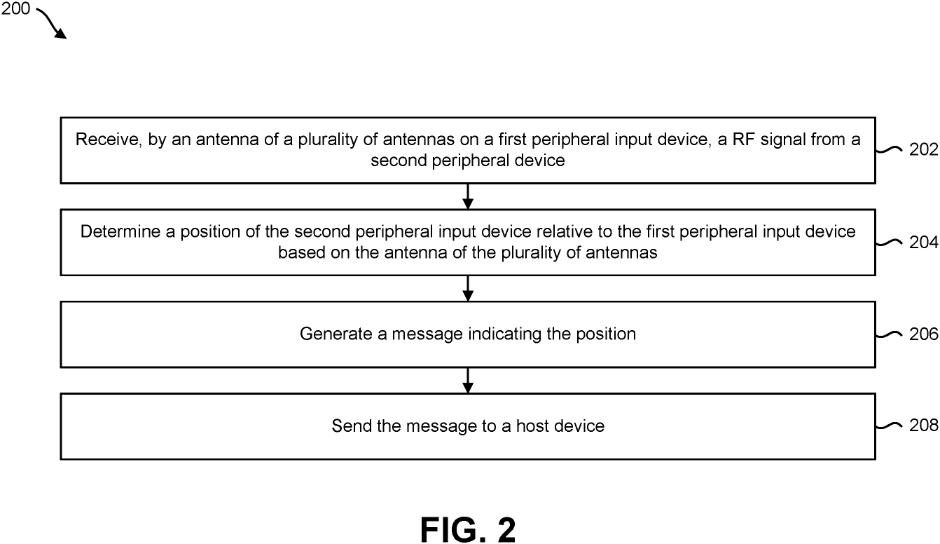

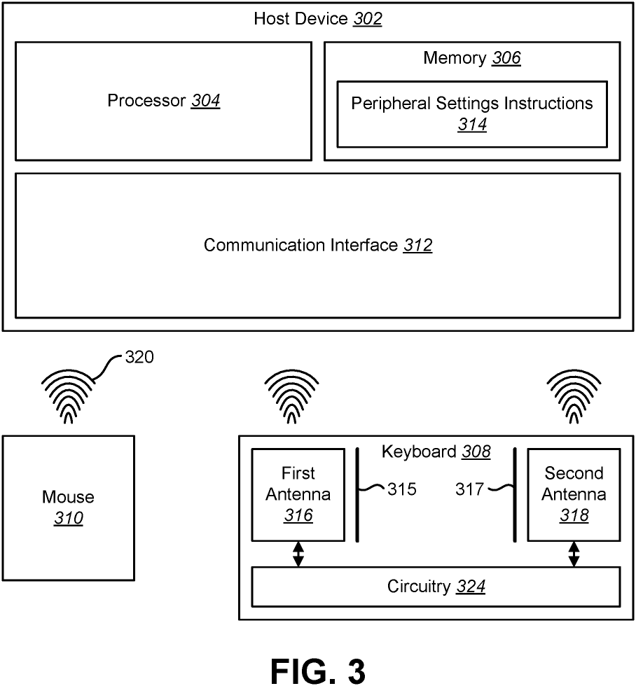

FIG. 2 is a flow diagram illustrating an example of a method 200 for determining a relative position of an peripheral input device. The method 200 or a method 200 element or elements may be performed by an electronic device (e.g., the peripheral input device). For example, the method 200 may be performed by the first peripheral input device 109 described in relation to FIG. 1 and/or the keyboard 308 described in relation to FIG. 3.

A first peripheral input device may receive 202, by an antenna of a plurality of antennas on the first peripheral input device, a RF signal from a second peripheral input device. In some examples, receiving the RF signal may be performed as described in relation to FIG. 1.

The first peripheral input device may determine 204 a position of the second peripheral input device relative to the first peripheral input device based on the antenna of the plurality of antennas. In some examples, determining 204 the position of the second peripheral input device may be performed as described in relation to FIG. 1. In some examples, determining the position may include determining whether the second peripheral input device is positioned to a left side of the first peripheral input device or to the right side of the second peripheral input device based on the antenna of the plurality of antennas. For instance, the location (e.g., zone) of the antenna that received the RF signal and/or that received the RF signal with the highest signal strength may indicate the position of the second peripheral input device relative to the first peripheral input device. For example, if an antenna on the right side (e.g., in the right side of the keyboard housing) received the RF signal or received the RF signal with a greater signal strength than the other antenna(s), the first peripheral input device may determine that the second peripheral input device is positioned on a right side of the first peripheral input device. For instance, the first peripheral input device may determine the antenna as an antenna receiving the RF signal with a highest signal strength.

The first peripheral input device may generate 206 a message indicating the position. For example, the first peripheral input device (e.g., circuitry) may encode a message that indicates the position of the second peripheral input device. For instance, the message may include a number(s), symbol(s), and/or character(s) indicating the position (e.g., ‘0’ indicating a left side, ‘1’ indicating a right side, ‘left,’ ‘right,’ ‘front,’ ‘back,’ etc.). In some examples, generating 206 the message may include inserting an identifier of the second peripheral input device from the received RF signal.

The first peripheral input device may send 208 the message to a host device. In some examples, sending 208 the message to the host device may be performed as described in relation to FIG. 1.

In some examples, an element or elements of the method 200 may be performed utilizing a sensor(s) and/or signal(s) as described in relation to FIG. 1. For instance, the first peripheral input device may receive, using a sensor(s), a signal from a signal peripheral device, where the sensor(s) may include RFID reader(s), image sensor(s), depth sensor(s), proximity sensor(s), and/or infrared sensor(s). In some examples, the first peripheral input device may determine a position of the second peripheral input device relative to the first peripheral input device based on the sensor that received the signal.

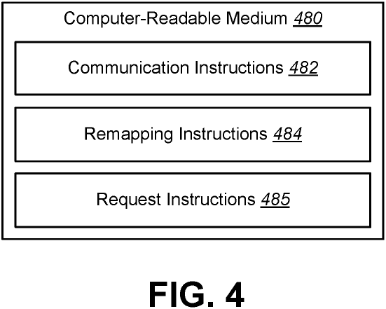

FIG. 3 is a block diagram of an example of a host device 302, a mouse 310, and a keyboard 308 that may be used in relative position determination. The host device 302 may be an example of the host device 103 described in relation to FIG. 1, the keyboard 308 may be an example of the first peripheral input device 109 described in relation to FIG. 1, and/or the mouse 310 may be an example of the second peripheral input device 111 described in relation to FIG. 1. In this example, the host device 302 includes a processor 304, a memory 306, and a communication interface 312. The host device 302 may include an additional component(s) (not shown), some of the components described herein may be removed or modified, or a combination thereof without departing from the scope of this disclosure. In this example, the keyboard 308 includes a first antenna 316, a first RF barrier 315, a second antenna 318, a second RF barrier 317, and circuitry 324. In some examples, the keyboard 308, the mouse 310, and/or the host device 302 may perform an operation or operations described in relation to FIG. 1, FIG. 2, and/or FIG. 4.

In the example of FIG. 3, the mouse 310 communicates with (e.g., provides input to) the host device 302 and the keyboard 308 communicates with (e.g., provides input to) the host device 302. In this example, the first antenna 316 receives an RF signal 320 from the mouse 310. The RF signal 320 is blocked or attenuated from being received by the second antenna 318 due to the first RF barrier 315 and the second RF barrier 317. The circuitry 324 receives signals provided by the first antenna 316 and the second antenna 318. The circuitry 324 determines that the mouse 310 is positioned to the left side of the keyboard 308 due to the RF signal 320 being received by the first antenna 316 (and not received by the second antenna 318 or weakly received by the second antenna 318). The circuitry 324 generates a message indicating the position and sends the message to the host device 302 (using the first antenna 316 and/or the second antenna 318).

On the host device 302, the processor 304 is an electronic circuit to execute an instruction or instructions. The processor 304 may be any of a processor, central processing unit (CPU), a digital signal processor (DSP), a semiconductor-based microprocessor, graphics processing unit (GPU), field-programmable gate array (FPGA), an application-specific integrated circuit (ASIC), other hardware device, or a combination thereof suitable for retrieval and execution of instructions stored in the memory 306. In some examples, the processor 304 may include multiple processors (e.g., a CPU and a GPU). The processor 304 may fetch and execute instructions stored in the memory 306. In some examples, the processor 304 may include an electronic circuit or circuits that include electronic components for performing a function or functions of the instructions.

The memory 306 is electronic circuitry to store data. The memory 306 may be any electronic, magnetic, optical, or other physical storage device that contains or stores electronic data (e.g., instructions, information, or a combination thereof). The memory 306 may be, for example, Random Access Memory (RAM), EEPROM, a storage device, an optical disc, or a combination thereof. In some examples, the memory 306 may be volatile memory, non-volatile memory, or a combination thereof, such as DRAM, EEPROM, MRAM, PCRAM, memristor, flash memory, or a combination thereof. In some examples, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)).

The communication interface 312 is circuitry to communicate with an external device or devices (e.g., the mouse 310 and the keyboard 308). An example of the communication interface 312 is a Bluetooth^{Ⓡ}interface. In some examples, the host device 302 may be in communication with (e.g., coupled to, have a communication link with) the mouse 310 and keyboard 308 via the communication interface 312. For example, the host device 302 may be paired with the mouse 310 and may be paired with the keyboard 308.

In some examples, the memory 306 stores peripheral settings instructions 314. The peripheral settings instructions 314 are instructions to adjust a setting or settings of a peripheral input device (e.g., the mouse 310). For example, the host device 302 may receive the message from the keyboard 308 via the communication interface 312. The processor 304 may execute the peripheral settings instructions 314 to remap buttons on the mouse 310. For instance, if the mouse 310 has swapped sides with the keyboard 308, the processor 304 may swap button mappings (e.g., left button to right button, and right button to left button). Accordingly, the host device 302 may interpret inputs from the mouse 310 differently (e.g., left click as a right click, and a right click as a left click).

FIG. 4 is a block diagram illustrating an example of a computer-readable medium 480 for peripheral input device control. The computer-readable medium 480 is a non-transitory, tangible computer-readable medium. In some examples, the computer-readable medium 480 may be, for example, RAM, DRAM, EEPROM, MRAM, PCRAM, a storage device, an optical disc, the like, or a combination thereof. In some examples, the computer-readable medium 480 may be volatile memory, non-volatile memory, or a combination thereof. In some examples, the computer-readable medium 480 described in FIG. 4 may be an example of the memory 306 described in FIG. 3.

The computer-readable medium 480 may include data (e.g., information and/or instructions). In the example of FIG. 4, the computer-readable medium 480 includes communication instructions 482, remapping instructions 484, and request instructions 485.

The communication instructions 482 may include instructions when executed cause a processor of an electronic device (e.g., host device) to receive a message from a peripheral input device indicating an arrangement of peripheral input devices based on a signal detection among the peripheral input devices. In some examples, the signal detection may be performed as described in relation to FIG. 1, FIG. 2, and/or FIG. 3. In some examples, receiving the message may be performed as described in relation to FIG. 1, FIG. 2, and/or FIG. 3.

The remapping instructions 484 may include instructions when executed cause the processor to remap an input of one of the peripheral input devices based on the message. In some examples, remapping the input may be performed as described in FIG. 1, FIG. 2, and/or FIG. 3. In some examples, the remapping instructions 484 may include instructions when executed cause the processor to determine that the arrangement of the peripheral input devices is different from a previous arrangement. For instance, the processor may compare the reported arrangement (e.g., second peripheral input device is positioned to the left of the first peripheral input device) with a previously stored arrangement. In a case that the reported arrangement is different, the processor may remap an input of one of the peripheral input devices. For instance, the processor may interpret an input (e.g., left click) of a mouse differently (e.g., as a right click).

The request instructions 485 may include instructions when executed cause a processor of an electronic device to generate a user interface request to confirm an input remap. For instance, the processor may generate a graphical user interface (GUI), an audio message, an image, a tone, etc. The processor may cause an output device (e.g., monitor, speaker, etc.) to output the user interface request. The user interface request may request confirmation to change peripheral input device settings (e.g., remap a button(s), swap button(s), etc.). For example, the user interface request may be a dialog box presented on a display that requests whether the user wants to allow a remap based on a detected rearrangement of peripheral input devices. In some examples, the processor (e.g., host device) may receive an input (e.g., click, button press, speech, gesture, etc.) indicating confirmation or denial of the remapping. The processor may execute the remapping or may cancel the remapping in accordance with the received input.

As used herein, items described with the term “or a combination thereof” or “and/or” may mean an item or items. For example, the phrase “A, B, C, or a combination thereof” may mean any of: A (without B and C), B (without A and C), C (without A and B), A and B (without C), B and C (without A), A and C (without B), or all of A, B, and C.

While various examples of systems and methods are described herein, the systems and methods are not limited to the examples. Variations of the examples described herein may be implemented within the scope of the disclosure. For example, operations, functions, aspects, or elements of the examples described herein may be reordered, omitted, or combined.

What is claimed is:

1. A first peripheral input device, comprising:
a sensor to receive a signal from a second peripheral input device; and
circuitry coupled to the sensor, wherein the circuitry is to:
determine a peripheral input device position relative to a keyboard based on the signal; and
send, to a host device, a message indicating the peripheral input device position relative to the keyboard.

2. The first peripheral input device of claim 1, wherein the first peripheral input device is the keyboard, and the second peripheral input device is a mouse.

3. The first peripheral input device of claim 2, wherein the sensor comprises a first antenna disposed at a first location of the keyboard and a second antenna disposed at a different second location of the keyboard.

4. The first peripheral input device of claim 3, wherein the circuitry is to determine the peripheral input device position based on receiving the signal by the first antenna while not receiving the signal by the second antenna or receiving the signal with attenuated signal strength by the second antenna.

5. The first peripheral input device of claim 3, further comprising an RF barrier between the first antenna and the second antenna.

6. The first peripheral input device of claim 1, wherein the first peripheral input device is a mouse, and the second peripheral input device is the keyboard.

7. The first peripheral input device of claim 1, wherein the circuitry is to determine the peripheral input device position by identifying a signal correspondence.

8. The first peripheral input device of claim 1, wherein the message is to cause the host device to determine whether to remap a peripheral input device button.

9. The first peripheral input device of claim 1, wherein the sensor comprises a radio frequency identification (RFID) reader, image sensor, depth sensor, or proximity sensor.

10. A method, comprising:
receiving, by an antenna of a plurality of antennas on a first peripheral input device, a RF signal from a second peripheral input device;
determining a position of the second peripheral input device relative to the first peripheral input device based on the antenna of the plurality of antennas;
generating a message indicating the position; and
sending the message to a host device.

11. The method of claim 10, wherein determining the position comprises determining whether the second peripheral input device is positioned to a left side of the first peripheral input device or to a right side of the second peripheral input device based on the antenna of the plurality of antennas.

12. The method of claim 11, further comprising determining the antenna as an antenna receiving the RF signal with a highest signal strength.

13. A non-transitory tangible computer-readable medium comprising instructions when executed cause a processor of an electronic device to:
receive a message from a peripheral input device indicating an arrangement of peripheral input devices based on a signal detection among the peripheral input devices; and
remap an input of one of the peripheral input devices based on the message.

14. The non-transitory tangible computer-readable medium of claim 13, wherein the instructions when executed further cause the processor to determine that the arrangement of the peripheral input devices is different from a previous arrangement.

15. The non-transitory tangible computer-readable medium of claim 14, wherein the instructions when executed further cause the processor to generate a user interface request to confirm an input remap.
